(19) United States
(12) Patent Application Publication
(10) Pub. No.: US 2011/0244719 A1
(43) Pub. Date: Oct. 6, 2011

(54) JUNCTION BOX WITH IMPROVED HEAT DISSIPATION

(75) Inventors: Zhang-Lan Xue, Kunshan (CN); Hong-Qiang Han, Kunshan (CN); Zi-Qiang Zhu, Kunshan (CN)

(73) Assignee: HON HAI PRECISION INDUSTRY CO., LTD., New Taipei (TW)

(21) Appl. No.: 13/075,204

(22) Filed: Mar. 30, 2011

(30) Foreign Application Priority Data
Mar. 31, 2010 (CN) 201010137176.3

(51) Int. Cl. H01R 13/60

(52) U.S. Cl. 439/575; 439/527; 439/574

(57) ABSTRACT

A junction box includes an outer box with a housing at a lower side thereof and a cavity above the housing, and a number of contacts retained on the housing. Each contact has a flat base portion, a first connecting portion and a second connecting portion at two ends thereof for connecting with a foil conductor of a photovoltaic module and a cable respectively. Each contact is formed with at least one side arm upwardly protruding into the cavity from one lateral side of the base portion.

### BACKGROUND OF THE INVENTION

1. Field of the Invention

The present invention relates to a junction box, and more particularly to a junction box having contacts with a large exposed area for good heat dissipation.

2. Description of Related Art

Junction boxes are widely used for electrically connecting a photovoltaic (PV) module to a power distribution system. Each junction box includes a housing that is mounted on a dielectric substrate of the corresponding PV module. The housing holds a plurality of electrical contacts which engage with a foil conductor that interconnects PV cells through the dielectric substrate to electrically connect the PV module to the junction box. The electrical contacts present as a flat metal sheet retained on an inner bottom wall of the housing. Besides, the junction box is electrically connected to the power distribution system via cables that electrically connect to the electrical contacts of the junction box. When electric current generated by the PV module flows through the junction box to the power distribution system, the electrical contacts would generate heat and dissipate heat to an inner cavity of the junction box. Then when the junction box is used to transmit a large electric current, heat generated by the contacts will not be dissipated out in time, which would destroy the junction box easily.

Hence, an improved junction box is desired to overcome the above problems.

### BRIEF SUMMARY OF THE INVENTION

According to the present invention, a junction box, comprises: an outer box with a housing at a lower side thereof and a cavity above the housing; and a plurality of contacts retained on the housing, each contact having a flat base portion, a first connecting portion and a second connecting portion at two ends thereof for connecting with a foil conductor of a photovoltaic module and a cable respectively; wherein each contact is formed with at least one side arm upwardly protruding into the cavity from one lateral side of the base portion.

According to another aspect of the present invention, a contact used in a junction box for electrically connecting a photovoltaic module, comprises: a flat base portion; a first connecting portion extending from one end of the base portion for connecting with a foil conductor of the photovoltaic module; and a second connecting portion extending from another end of the base portion for connecting with a cable; wherein the base portion is formed with at least one side arm upwardly extending from one lateral side thereof to be exposed in air, and the side arm defines a plurality of cutouts recessed from a top end thereof.

The foregoing has outlined rather broadly the features and technical advantages of the present invention in order that the detailed description of the invention that follows may be better understood. Additional features and advantages of the invention will be described hereinafter which form the subject of the claims of the invention.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 is a perspective view of a junction box of the present invention;

FIG. 2 is a view similar to FIG. 1, while taken from a different aspect;

FIG. 3 is a partly exploded view of the junction box shown in FIG. 1;

FIG. 4 is a view similar to FIG. 3, while taken from a different aspect;

FIG. 5 is an exploded view of the junction box shown in FIG. 1;

FIG. 6 is a view similar to FIG. 5, while taken from a different aspect; and

FIG. 7 is a perspective view of a contact of the junction box shown in FIG. 5.

### DETAILED DESCRIPTION OF THE PREFERRED EMBODIMENT

In the following description, numerous specific details are set forth to provide a thorough understanding of the present invention. However, it will be obvious to those skilled in the art that the present invention may be practiced without such specific details. In other instances, well-known circuits have been shown in block diagram form in order not to obscure the present invention in unnecessary detail. For the most part, details concerning timing considerations and the like have been omitted inasmuch as such details are not necessary to obtain a complete understanding of the present invention and are within the skills of persons of ordinary skill in the relevant art.

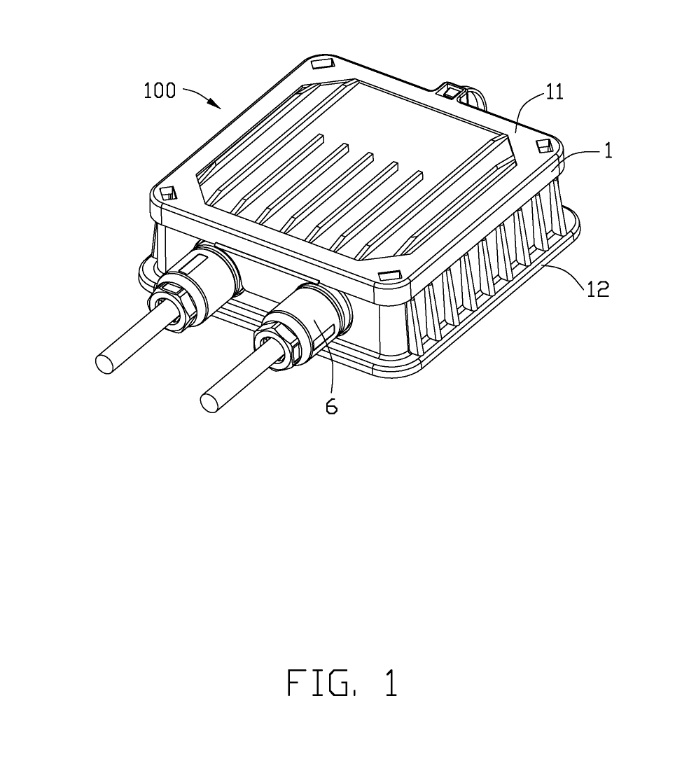

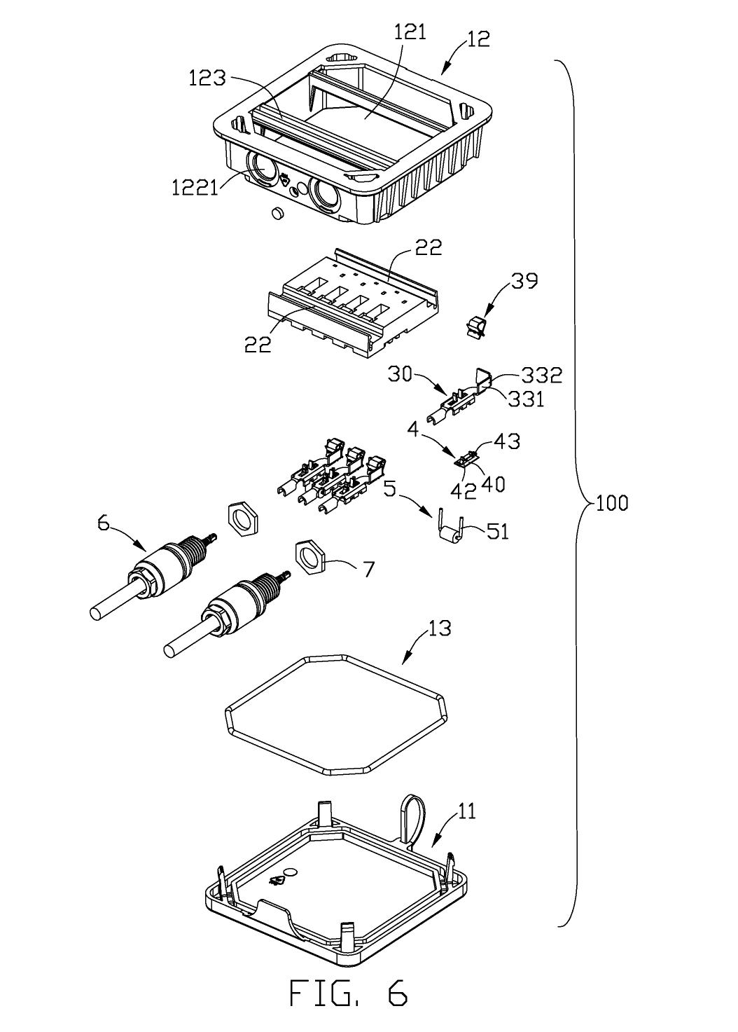

Referring to FIGS. 1-7, a junction box 100 used for electrically connecting a photovoltaic (PV) module (not shown) to a power distribution system (not shown) according to the present invention is disclosed. The junction box 100 comprises an outer box 1, a housing 2 attached to an inner side of the outer box 1, and a plurality of contacts 3 retained on the housing 2 to electrically connect two cables 6 and foil conductors (not shown) on the PV module.

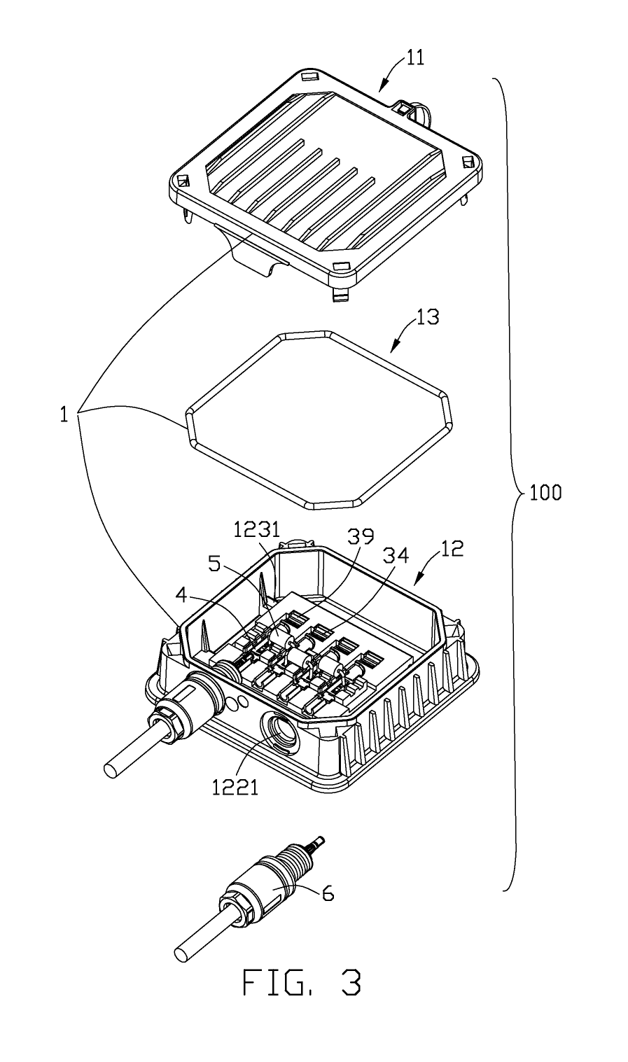

Referring to FIGS. 3-6, the outer box 1 presents as a square box, and comprises a lower box 12, a cover 11 covering an upper side of the lower box 12, and an o-ring 13 attached to the cover 11. The o-ring 13 seals the outer box 1 when the cover 11 is covered to the lower box 12, which can prevent water from flowing into an inner side of the junction box 100. The lower box 12 is formed with four side walls 122 which connect with each other one by one, a pair of bridges 123 connecting lower ends of opposite two side walls 122, and a cavity 121 surrounded by the side walls 122. The side walls 122 comprise a connecting wall 1223 which is formed with a pair of cable holes 1221 and a plurality of blocks 1222 protruding inwardly into the cavity 121 from an inner side thereof The blocks 1222 are arranged at two sides of the cable holes 1221 and extend along an up to down direction. The cover 11 has a plurality of hooks 111 downwardly extending from four corners thereof to lock with the lower box 12. The lower box 12 defines four locking holes 124 at four corners thereof to lock with the hooks 111.

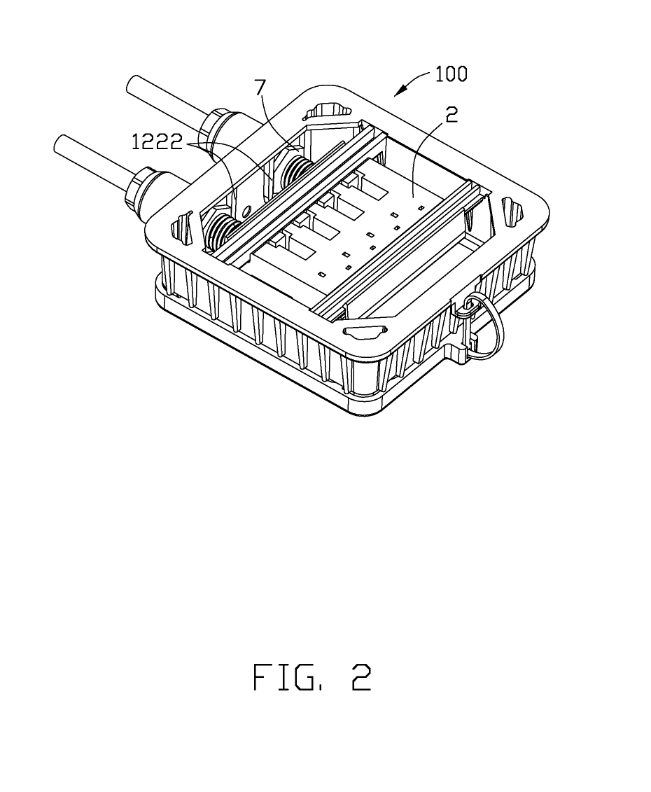

Referring to FIGS. 2-6, the housing 2 engages with the bridges 123 to act as a bottom wall of the outer box 1, and the cavity 121 is located above the housing 2. Of course, the housing 2 used as the bottom wall of the outer box 1 also can be unitarily formed with the outer box 1. The housing 2 has a rectangular body portion 20, a plurality of slots 21 recessed from a top surface thereof, a number of fences 23 upwardly and integrally protruding from the top surface thereof, and a pair of grooves 22 upwardly recessed from a bottom surface thereof to receive and lock the bridges 123. The fences 23 are arranged at two lateral sides of the slots 21, and the fences 23 and the slots 21 extend along a front to back direction. Each fence 23 defines a plurality of depressions 230 at a top end thereof.

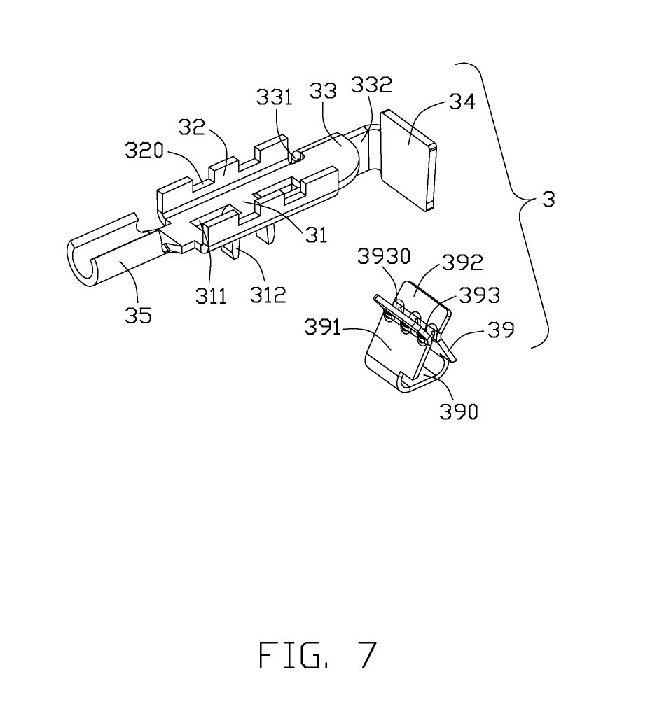

Referring to FIGS. 3 and 7, the contacts 3 are retained in the slots 21. Each contact 3 has a flat base portion 31, a first connecting portion 34 and a second connecting portion 35 respectively located at two ends thereof, a bending portion 33 connecting between one end of the base portion 31 and the first connecting portion 34, and a pair of side arms 32 bending upwardly from two lateral sides of the base portion 31. The side arms 32 extend along an elongated direction of the contacts 3, and affix to the fences 23 along a transverse direction perpendicular to the elongated direction for preventing the side arms 32 from being deformed. The front to back direction is same as the elongated direction in the present invention.

The base portion 31 is received in the slot 21 and upwardly exposed to the cavity 121. The base portion 31 defines a pair of through holes 311 and a pair of first tabs 312 downwardly punctured from two adjacent inner ends of said two through holes 311. The bending portion 33 and the first connecting portion 34 are also received in the slot 21. The bending portion 33 has a vertical portion 331 downwardly extending from one end of the base portion 31, and an extension portion 332 extending backwardly from the vertical portion 331. The vertical portion 331 and the extension portion 332 are located at a same plane. The first connecting portion 34 bends from a rear end of the extension portion 332 and is perpendicular to the extension portion 332 and the base portion 31. The second connecting portion 35 presents as a curling type to fasten one end of the cable 6 therein. Each side arm 32 upwardly protrudes into the cavity 121, and defines a number of cutouts 320 at a top end thereof. The cutouts 320 has a large inner surface and a large side surface which is exposed to the cavity, therefore, the contacts 3 can further dissipate heat via the increased exposed area, which can improve the heat dissipation of the junction box 100 in the present invention. Besides, the cutouts 320 are aligned with the depressions 230 of the fences 23, which can increase flowing passageway of the heat.

Each contact 3 further has a clamp spring 39 attached to the first connecting portion 34 for electrically connecting the first connecting portion 34 and the foil conductor. The clamp spring 39 has a horizontal flat portion 390 and a pair of clip arms 391 upwardly extending from two sides of the flat portion 390 and closed to each other. Each clip arm 391 has a clip portion 393 protruding toward another clip arm 391 and an end portion 392 outwardly extending to keep away from another clip arm 391 at a top end of the clip portion 393. The first connecting portion 34 is sandwiched between the clip arms 391. When the junction box 100 is assembled to the PV module, the foil conductors are set between the clip arms 391 to electrically connect with the first connecting portion 34, and the foil conductors and the first connecting portions 34 are sandwiched between the clip portions 393. In addition, each clip portion 393 defines a plurality of recesses 3930 to make the clip portions 393 contact with the first connecting portion 34 or the foil conductors in more points, which can strengthen the retention of the clamp spring 39.

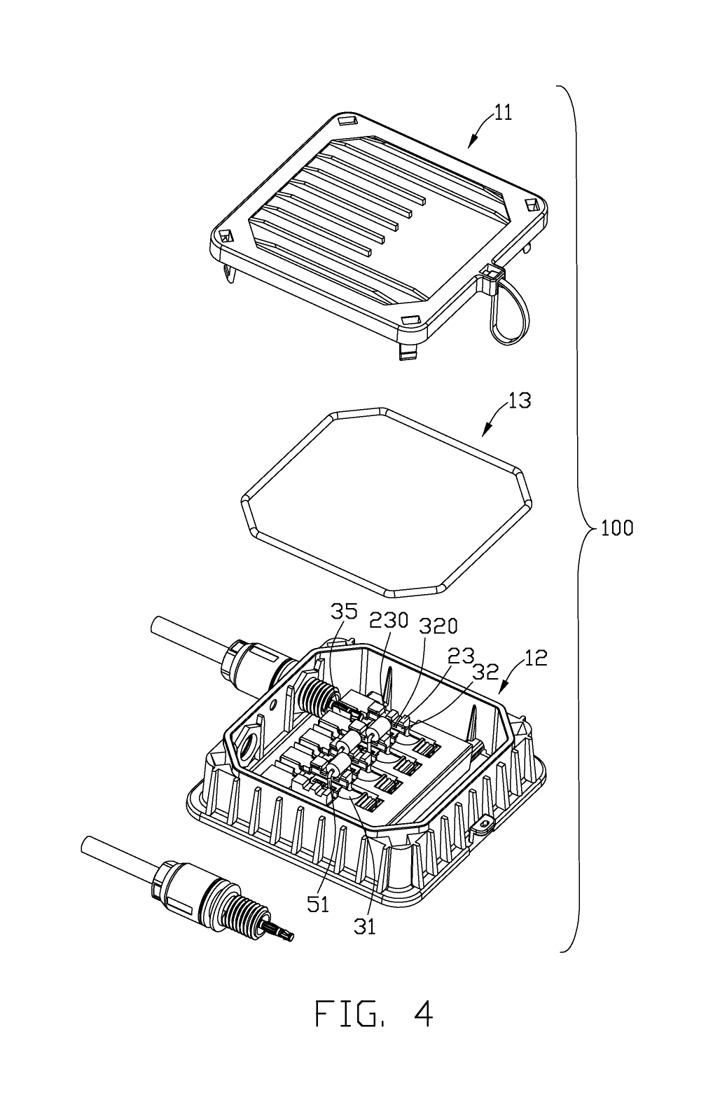

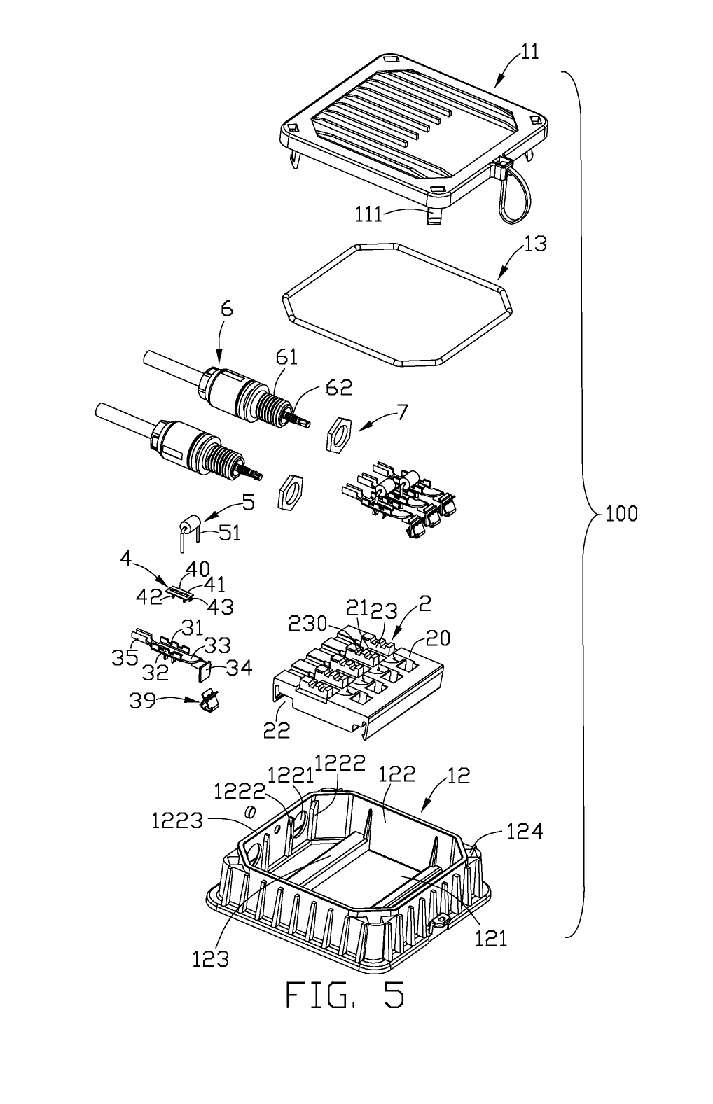

Referring to FIGS. 4 and 5, the junction box 100 in the present invention further comprises a fastening strip 4 retained on the base portion 31 of the contact 3. The fastening strip 4 has a flat base 40, a pair of through holes 41 punctured from a middle position of the base 40, a pair of second tabs 42 downwardly extending from opposite two inner ends of the through holes 41, and a pair of barbs 43 downwardly bending from two outer ends of the base 40. The base 40 affixes to the base portion 31 of the contact 3. The through holes 41 of the fastening strip 4 are aligned with the through holes 311 of the base portion 31 along an up to down direction. The second tabs 42 pass through the through holes 311 of the contacts 3 to form a pair of clamp portions with the first tabs 312. The barbs 43 also pass through the through holes 311 to engage with outer ends of the through holes 311, which can lock the fastening strip 4 to the base portion 31.

Referring to FIGS. 4 and 5, the junction box 100 further comprises a plurality of diodes 5 electrically connecting adjacent two contacts 3 along the transverse direction. Each diode 5 has a pair of tails 51 downwardly extending at two sides thereof The two tails 51 on each diode 5 are sandwiched by the clamp portions of adjacent contacts 3 and fastening strips 4 assembly.

Referring to FIGS. 1 and 5, each cable 6 has a screw portion 61, a conducting wire 62 protruding into the cavity 121 to electrically connect with the contacts 3. The conducting wire 62 is retained in the curling type second connecting portion 35. Besides, the junction box 100 in the present invention has a nut 7 which is sandwiched between the blocks 1222 of the lower box 12. The nut 7 engages with the screw portion 61 of the cable 6 to fix the cable 6 to the lower box 12.

As fully described above, each contact 3 in the present invention is formed with a pair of side arms 32 upwardly protruding and exposed into the cavity 121, and each side arm 32 defines a plurality of cutouts 320 to form a large area of exposed outer surface. Then the heat dissipation surface is increase, which can improve heat dissipation of the junction box 100.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

What is claimed is:

1. A junction box, comprising:
an outer box with a housing at a lower side thereof and a cavity above the housing; and
a plurality of contacts retained on the housing, each contact having a flat base portion, a first connecting portion and a second connecting portion at two ends thereof for connecting with a foil conductor of a photovoltaic module and a cable respectively;
wherein each contact is formed with at least one side arm upwardly protruding into the cavity from one lateral side of the base portion.

2. The junction box according to claim 1, wherein the side arm defines at least one cutout at a top end thereof.

3. The junction box according to claim 2, wherein each contact has a pair of said side arms respectively extending from two lateral sides of thereof and exposed to the cavity.

4. The junction box according to claim 2, wherein the housing defines a plurality of slots, the base portion is received in the slot and upwardly exposed to the cavity, and the side arm extends along an elongated direction of the contact.

5. The junction box according to claim 4, wherein the housing is form with a plurality of fences upwardly protruding from a top surface thereof and respectively located at two lateral sides of the slots.

6. The junction box according to claim 5, wherein the side arms affix to the fences along a transverse direction perpendicular to the elongated direction, and each fence defines corresponding depressions aligning with the cutouts along the transverse direction.

7. The junction box according to claim 1, wherein the base portion is formed with a pair of first tabs downwardly punctured and a pair of through holes at an outer side of the first tabs.

8. The junction box according to claim 7, further comprising a fastening strip attached to the base portion, the fastening strip is formed with a pair of second tabs downwardly punctured, a pair of through holes at an inner side of the second tabs, and a pair of barbs downwardly extending from front and back ends thereof to lock with the contact, and the second tabs pass through the through holes of the base portion to form a pair of clamp portions with the first tabs for fixing a tail of a diode.

9. The junction box according to claim 1, wherein each contact has a bending portion connecting one end of the base portion and the first connecting portion, and the bending portion, the base portion and the first connecting portion are perpendicular to each other.

10. The junction box according to claim 9, further comprising a plurality of clamp springs received in one end of the slots, the clamp spring clamps the first connecting portion therein.

11. A contact used in a junction box for electrically connecting a photovoltaic module, comprising:
a flat base portion;
a first connecting portion extending from one end of the base portion for connecting with a foil conductor of the photovoltaic module; and
a second connecting portion extending from another end of the base portion for connecting with a cable;
wherein the base portion is formed with at least one side arm upwardly extending from one lateral side thereof to be exposed in air, and the side arm defines a plurality of cutouts recessed from a top end thereof.

12. The contact according to claim 11, wherein the contact has a pair of said side arms upwardly extending from two lateral sides thereof.

13. The contact according to claim 12, wherein the side arm extends along an elongated direction of the contact.

14. The contact according to claim 13, wherein each contact has a bending portion connecting one end of the base portion and the first connecting portion, and the bending portion, the base portion and the first connecting portion are perpendicular to each other.

15. A contact assembly comprising:
a housing defining a plurality of parallel slots extending in a lengthwise direction, each of said slots defined between two adjacent fences;
a plurality of contacts disposed in the corresponding slots, respectively;
a plurality of diodes supportably seated upon the corresponding fences, respectively, each of said diodes defining two opposite leads respectively mechanically and electrically connected to the two adjacent contacts located by two sides of the corresponding fence.

16. The contact assembly as claimed in claim 15, wherein each of said contacts defines a base located between the two adjacent fences with a rear end connected to a corresponding cable and a front end connected to a conductor linked to a photovoltaic module, and at least one side arm upwardly extending from one lateral side edge of the base and intimately confronting the corresponding fence in a transverse direction perpendicular to lengthwise direction.

17. The contact assembly as claimed in claim 16, wherein the front end of the contact is connected to the conductor via a clamp spring.

18. The contact assembly as claimed in claim 15, wherein each of said fences defines a cutout to compliantly receive at least a lower portion of the corresponding diode.

19. The contact assembly as claimed in claim 18, wherein each of said contacts defines a base located between the two adjacent fences with a rear end connected to a corresponding cable and a front end connected to a conductor linked to a photovoltaic module, and at least one side arm upwardly extends from one lateral side edge of the base and intimately confronting the corresponding fence in a transverse direction perpendicular to lengthwise direction, and said side arm defines a notch compliant and aligned with the corresponding cutout in the transverse direction for receiving the lower portion of the corresponding diode.

20. The contact assembly as claimed in claim 15, wherein the lead of the diode is connected to the corresponding contact via a fastening strip.
